(19) United States
(12) Patent Application Publication
(10) Pub. No.: US 2015/0352955 A1
(43) Pub. Date: Dec. 10, 2015

(54) MOVING BODY STATE INFORMING APPARATUS, SERVER SYSTEM AND MOVING BODY STATE INFORMING METHOD

(71) Applicant: MITSUBISHI ELECTRIC CORPORATION, Tokyo (JP)

(72) Inventors: Yoshihiko MORI, Tokyo (JP); Takuji MORIMOTO, Tokyo (JP); Yasunori HOSHIHARA, Tokyo (JP)

(73) Assignee: MITSUBISHI ELECTRIC CORPORATION, Tokyo (JP)

(21) Appl. No.: 14/759,465

(22) PCT Filed: Apr. 18, 2013
(86) PCT No.: PCT/JP2013/061496

§ 371 Date: Jul. 7, 2015

(51) Int. Cl. B60K 35/00

(52) U.S. Cl. CPC B60K 35/00; B60K 2350/1076

(57) ABSTRACT

A moving body state informing apparatus includes a vehicle information acquiring unit 2 that acquires vehicle information indicating various states of a vehicle; a state deciding unit 3 that decides the general state of the vehicle by estimating as a whole the contents of the various states of the vehicle indicated by the vehicle information the vehicle information acquiring unit 2 acquires; and an informing processor 4 that outputs the general state of the vehicle the state deciding unit 3 decides to an output unit 6 to give information.

### TECHNICAL FIELD

The present invention relates to a moving body state informing apparatus, a server system and a moving body state informing method that give information about the state of a moving body like a vehicle to a user.

### BACKGROUND ART

As a conventional technique that gives information about a vehicle state to a crew member of the vehicle, a Patent Document 1, for example, discloses a navigation system capable of causing a user to recognize an approximate speed of the vehicle without the sacrifice of the map area being displayed. The navigation system displays a current position mark using a comic character corresponding to a speed index determined in advance. Thus, the user can recognize the approximate speed of the vehicle with ease such as if the current position on the map display area is indicated by a turtle mark, the speed of the vehicle is less than 30 km/h, and if indicated by a rabbit mark, the speed of the vehicle is not less than 30 km/h and less than 60 km/h. In addition, since the current position mark is a comic character corresponding to the speed, it is not necessary to provide an area for displaying the vehicle speed newly within the map display area, thereby being able to prevent the sacrifice of the map display area.

In addition, a Patent Document 2 discloses a navigation system that executes a vehicle-linked application using a detection result of a running state of a vehicle. The navigation system, for example, switches actions of a comic character being displayed in accordance with the speed of the vehicle. When the comic character being displayed is a fish in a tank of an aquarium application, its swimming manner alters in accordance with the running state of the vehicle. By thus doing, a crew member of the vehicle can grasp the running state of the vehicle intuitively.

Incidentally, as various items of information indicating the running state of the vehicle, the Patent Document 2 prescribes besides the speed of the vehicle a direction, a height, the presence or absence of lighting and so on, and switches the actions of the comic character in accordance with the information.

### PRIOR ART DOCUMENT

### Patent Document

Patent Document 1: Japanese Patent Laid-Open No. 8-128838/1996.

Patent Document 2: Japanese Patent Laid-Open No. 2004-301546.

### DISCLOSURE OF THE INVENTION

### Problems to be Solved by the Invention

The conventional technique typified by the Patent Document 1 displays the mark corresponding only to the speed of the vehicle. By applying the conventional technique to a state other than the speed of the vehicle, it can display a mark corresponding to various states of the vehicle.

In this case, however, it only informs a user of the various states separately by displaying marks of the various states of the vehicle. Accordingly, the user cannot grasp the general state of the vehicle, which is decided as a whole considering such states as the remaining amount of fuel and engine speed in addition to the speed of the vehicle.

Accordingly, the user must judge the various states of the vehicle individually. Thus, unless the user understands the contents of the various states, a problem arises of being unable to decide the vehicle state accurately.

For example, even in a state where the vehicle is running at an appropriate engine speed and at an appropriate speed, if the remaining amount of fuel is reducing and oil supply is recommended as the general state of the vehicle, unless the driver confirms the information about the remaining amount of fuel pinpointly, he or she cannot grasp the general state of the vehicle.

In addition, for a passenger other than the driver, the information about the various states of the vehicle is only troublesome because he or she does not drive, and it is easier to perceive or more preferable to be informed of the general state of the vehicle which is decided overall about the various states of the vehicle.

Furthermore, in the Patent Document 2, it executes the vehicle-linked application in accordance with the various states of the vehicle.

The vehicle-linked application, however, does not operate in connection with the general state of the vehicle which is decided considering the various states of the vehicle as a whole, but the actions of the comic character is determined from the individual states of the vehicle.

Accordingly, to recognize the general state of the vehicle, a user must observe the actions of the comic character for a certain time period. Thus, the driver concentrating on the driving cannot recognize the general state of the vehicle easily.

The present invention is implemented to solve the foregoing problems. Therefore it is an object of the present invention to provide a moving body state informing apparatus, a server system and a moving body state informing method that enable a user without any skills of recognizing the various states of the moving body to understand the general state of the moving body with ease.

### Means for Solving the Problems

A moving body state informing apparatus in accordance with the present invention, which is mounted on a moving body to give information about the state of the moving body via an output unit, comprises: a moving body information acquiring unit that acquires moving body information indicating various states of the moving body; a state deciding unit that decides a general state of the moving body by estimating as a whole contents of the various states of the moving body indicated by the moving body information the moving body information acquiring unit acquires; and an informing processor that outputs the general state of the moving body the state deciding unit decides to the output unit to give information.

### Advantages of the Invention

According to the present invention, it offers an advantage of enabling the user without any skills of recognizing the various states of the moving body to recognize the general state of the moving body easily.

### BRIEF DESCRIPTION OF THE DRAWINGS

FIG. 1 is a block diagram showing a configuration of a moving body state informing apparatus of an embodiment 1 in accordance with the present invention;

FIG. 2 is a flowchart showing a moving body state informing method of the embodiment 1;

FIG. 3 is a diagram showing an information example of the general state of the vehicle;

FIG. 4 is a diagram showing an information example when information to be given urgently occurs;

FIG. 5 is a block diagram showing a configuration of a moving body state informing apparatus of an embodiment 2 in accordance with the present invention;

FIG. 6 is a flowchart showing a moving body state informing method of the embodiment 2;

FIG. 7 is a diagram showing an information example when an abnormality occurs in or around a vehicle;

FIG. 8 is a block diagram showing a configuration of a moving body state informing apparatus of an embodiment 3 in accordance with the present invention;

FIG. 9 is a diagram showing an information example of a vehicle state in the embodiment 3;

FIG. 10 is a block diagram showing other configurations of the moving body state informing apparatus of the embodiment 3;

FIG. 11 is a block diagram showing configurations of a moving body state informing apparatus of an embodiment 4 in accordance with the present invention; and

FIG. 12 is a diagram showing information examples of a vehicle state in the embodiment 4.

### BEST MODE FOR CARRYING OUT THE INVENTION

The best mode for carrying out the invention will now be described with reference to the accompanying drawings to explain the present invention in more detail.

### Embodiment 1

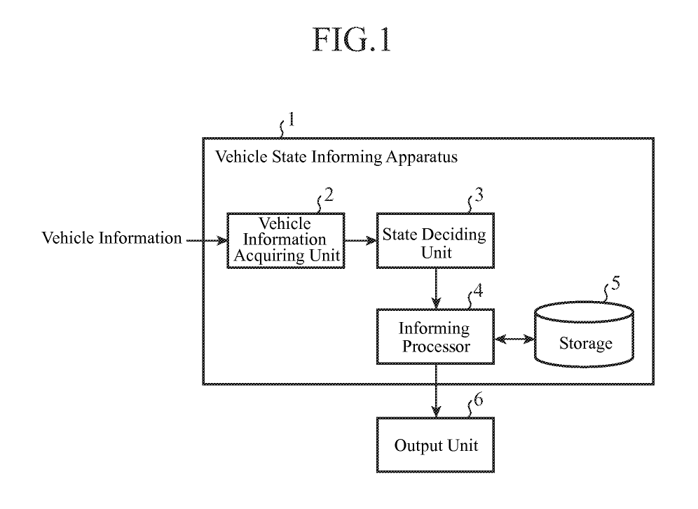

FIG. 1 is a block diagram showing a configuration of a moving body state informing apparatus of an embodiment 1 in accordance with the present invention. It is an apparatus which is mounted in or brought into a moving body such as a vehicle to give information about the state of the moving body to a crew member. The following description will be made using an example in which the moving body is a vehicle.

The vehicle state informing apparatus 1 shown in FIG. 1 is an apparatus which is mounted in a vehicle or brought into it by a crew member to inform the crew member of the vehicle state via an output unit 6, and which comprises a vehicle information acquiring unit 2, a state deciding unit 3, an informing processor 4 and a storage 5.

The vehicle information acquiring unit 2 is a moving body information acquiring unit that is connected to a vehicle sensor and a vehicle control apparatus installed in the vehicle, and acquires vehicle information indicating various states of the vehicle indicated by meters such as a speedometer and a fuel gauge and various states about a running state such as about the gear lever, steering, accelerator and brakes. The vehicle information that can be mentioned is the speed of the vehicle, the engine speed, the remaining amount of fuel, the drive position, bearings of the vehicle, an acceleration and deceleration state, the distance covered by the vehicle, the date and time, the current position and so on. Incidentally, the various states of the vehicle include at least one of the speed of the vehicle, the engine speed, the current position of the vehicle, the bearing, the distance covered, the traveling time, the drive position, the steering position, the opening of the accelerator and the state of the brakes as the acceleration and deceleration state of the vehicle, the remaining amount of fuel (gasoline and battery for a gasoline car and hybrid vehicle), the battery charged level (electric vehicle), the engine coolant temperature and the date and time.

The state deciding unit 3 decides the general state of the vehicle by estimating as a whole the contents of the various states of the vehicle indicated by the vehicle information the vehicle information acquiring unit 2 acquires.

A deciding method of the general state of the vehicle, for example, sets a threshold for each of the various states of the vehicle and a degree of priority (weight) in the decision of the general state in advance, estimates the high or low level of the contents of the various states by comparing the contents of the various states of the vehicle the vehicle information indicates with the thresholds, and gives points in accordance with the high or low level.

For example, as for the speed of the vehicle, the engine speed and the remaining amount of fuel, which the vehicle information indicates which is acquired from the speedometer of the vehicle, the tachometer and the fuel gauge, the method sets the thresholds at 50 km/h, 3000 rpm, and 10% for them, and gives point “1” to the various states when not less than the threshold, and point “2” to the various states when less than the threshold.

Incidentally, the thresholds are an indicator for classifying the various states into cases taking a typical value for safety's sake (normal value), a value to be recovered to the normal value urgently (urgent value), and a middle value (intermediate value) between them, and the thresholds can be a prescribed threshold range.

After that, the state deciding unit 3 multiplies the points of the contents of the various states by the degrees of priority (weights) set for the various states in advance to calculate the point values of the various states and the total point value of them.

For example, since the remaining amount of fuel is an important factor for maintaining the running of the vehicle, assume that the degree of priority of the remaining amount of fuel is set at “2”, but the degree of priority of the speed of the vehicle is set at “1”, and the degree of priority of the engine speed is set at “1”. When the speed of the vehicle and the engine speed are not less than the thresholds and the remaining amount of fuel is less than the threshold, for example, multiplying the points in accordance with the high or low levels of the speed of the vehicle, engine speed and remaining amount of fuel by the degrees of priority will results in the points of the speed of the vehicle, the engine speed and the remaining amount of fuel of “1”, “1” and “4” whose total becomes “6”. The point values of the various states and their total are supplied from the state deciding unit 3 to the informing processor 4 as the decision result of the general state of the vehicle.

In this way, the state deciding unit 3 obtains, as the information indicating the general state of the vehicle, the estimated values (point values) of the individual states of the vehicle, which result from estimating the contents of the states by combining the plurality of vehicle states selected in advance, and the total estimated value (the total value of the point values).

As for the thresholds for classifying the contents of the various states in the combination of the various states used for deciding the general state of the vehicle, the state deciding unit 3 can alter them in accordance with the contents of the states relating to each other in the combination. More specifically, in the combination of the various states, it sets a combination of the states further relating to each other, and in accordance with the contents of one state, it alters the threshold of the other state. As for such an alteration pattern of the thresholds corresponding to the combination of the related states and to the contents of the states, the state deciding unit 3 stores it in a read/write memory or storage 5. For example, consider the case where the combinations of road types of a running road of the vehicle and the speed of travel of the vehicle are set in advance. If the threshold for deciding whether or not the speed of travel is to be recovered to the normal value urgently (urgent value) is set at 40 km/h when the vehicle is running on a local road, and when the vehicle is running on an expressway, the threshold of the speed of travel is altered to 100 km/h.

In addition, consider the case where the combination is consists of the types of the running road of the vehicle, the speed of travel and the remaining amount of fuel. In reference to the state with a higher degree of priority, when the remaining amount of fuel with the highest degree of priority in the combination is less than the threshold of 5%, even if the vehicle is running on an expressway, the threshold of the speed of travel is altered to 80 km/h.

In this way, in order to alter the threshold in conformity with the contents of the states related to each other in the combination of the various states used for deciding the general state of the vehicle, the alteration patterns of the thresholds corresponding to the combination of the states related to each other and to the contents of the states are set and stored in advance. Thus, the state deciding unit 3 can alter the threshold by reading the alteration pattern in accordance with the contents of the states.

In addition, among the various states of the vehicle, since the high or low level about the state relating to the position of the vehicle (such as a state in which the vehicle is placed in a prescribed type of facilities) cannot be compared, a point corresponding to the type of the facilities is assigned in advance. Thus, when the vehicle placed in the type of the facilities, the point is given to be multiplied by a corresponding degree of priority.

Incidentally, the deciding method of the general state of the vehicle described above is only an example, and a method other than that is applicable as long as it can decide the general state of the vehicle by estimating the contents of the various states of the vehicle as a whole. As for the combination of the various states and the degree of priority used for deciding the general state of the vehicle, they can be altered in response to a user input (such as mode switching).

The combinations of the various states of the vehicle for each of a plurality of modes are stored with the degrees of priority (in a memory or storage 5 the state deciding unit 3 can read from or write into) so as to enable the state deciding unit 3 to select the combination and the degree of priority used for deciding the general state of the vehicle in response to the mode switching by the user.

In this case, it is assume that the combination includes at least the vehicle states relevant to the object of the mode, and among the states of the combination, the state desired to be recognized is given a high degree of priority.

For example, suppose a safe driving mode which has a combination including at least the vehicle states relevant to the safe driving (the speed of travel, steering position and the like). Among the states of the combination, higher degrees of priority are assigned in order to the states desired to be recognized for carrying out the safe driving (such as the speed of travel).

In addition, suppose an ecological driving mode which has a combination including at least the vehicle states relevant to the ecological driving (the remaining amount of fuel, acceleration and deceleration state and the like). Among the stated of the combination, higher degrees of priority are assigned in order to the states desired to be recognized for carrying out the ecological driving (such as the remaining amount of fuel).

Incidentally, a plurality of modes can use the same combination, and alter only the degrees of priority of the individual states.

Furthermore, the state deciding unit 3 decides a state to be informed urgently from the various states of the vehicle. For example, it decides that a state with the point not less than the prescribed threshold among the various states as the state to be informed urgently. The state of the decision result is supplied from the state deciding unit 3 to the informing processor 4 as the state to be informed urgently.

The informing processor 4 is an informing processor that gives information by supplying the output unit 6 with the general state of the vehicle the state deciding unit 3 decides. As a mode of expression of the general state of the vehicle, according to the point values of the various states of the vehicle and to their total value supplied from the state deciding unit 3, the informing processor 4 expresses the general state of the vehicle using a state with a higher point as the principal content and a state with a lower point as preliminary contents. For example, when the speed of the vehicle and the engine speed are not less than the thresholds, but the remaining amount of fuel is less than the threshold, the general state of the vehicle is expressed as a state where “although the running is good, oil supply is preferable if possible”. It is performed by the informing processor 4 that classifies the various states of the vehicle into the state relating to the running operation of the vehicle, the state relating to the fuel for maintaining the running, the state relating to the position of the vehicle and the like, that decides that a state requiring the expression of the urgent value occurs if the total value of the point values is not less than the threshold, and that selects and combines the expression of the normal value, the expression of the urgent value and the expression of the intermediate value in accordance with the point values of the various states. The informing processor 4, utilizing the data for providing information which is retained in the storage 5, creates one of the character data and voice data expressing the general state of the vehicle, and supplies it to the output unit 6.

In this way, from among the expression data set in advance (stored in the storage 5) in conformity with the estimated values of the individual states, the informing processor 4 selects the expressions corresponding to the estimated values (point values) of the individual states of the vehicle acquired from the state deciding unit 3 as the information indicating the general state of the vehicle, and creates the data for providing information that expresses the general state of the vehicle by combining the individual expressions selected.

Incidentally, the mode of expression of the general state of the vehicle described above is only an example, and any other modes can be applied as long as they can express the general state of the vehicle with simple contents.

For example, it is conceivable to express the general state of the vehicle in terms of the operation the vehicle is to perform next. When the speed of the vehicle is excessive, an expression prompting “deceleration” or “stop” is set in advance as an expression for an urgent case corresponding to the speed. More specifically, when only the speed of the vehicle indicates the urgent value of excessive speed among the various states, the expression indicating the state that “although the running is good, deceleration is required” is given.

In addition, the informing processor 4 can give information about the general state of the vehicle in an intuitive expression using at least one of the character, color, shape, pattern, comic character and voice.

For example, as for the individual states combined for the cases of the normal value, urgent value and intermediate value, respectively, the storage 5 stores in advance table data that records the data for providing information, which gives intuitive expressions of the individual states. The informing processor 4, using the data corresponding to the combination indicating the general state of the vehicle decided by the state deciding unit 3, searches the storage 5 and acquires the data for providing information corresponding to the states.

Incidentally, as for the data for providing information, which represents the general state of the vehicle in an intuitive expression, there are data expressing the general state of the vehicle in a simple sentence, in a simple figure, in a simple image pattern, in a comic character and its simple action, and in a simple voice guidance.

When the general state of the vehicle is a “running well” state, this can be further described in the intuitive expression “I'm fine”, for example.

Furthermore, when the state to be informed urgently occurs in the various states of the vehicle, the informing processor 4 can inform a user of the general state of the vehicle, which is decided using the various states including the state to be informed urgently, in an intuitive expression using at least one of the character, color, shape, pattern, comic character and voice. For example, when the remaining amount of fuel reduces considerably to the urgent value, and although the general state of the vehicle is “running well, but oil supply is required”, it can be further described in an intuitive sentence “I'm tired”, for example.

The storage 5 is one that stores the data for providing information used in the informing processing by the informing processor 4. Incidentally, as for the storage 5, a storage that can be read from the informing processor 4 properly is enough, and a hard disk drive (HDD), a USB memory and a disk drive, which are mounted in the vehicle state informing apparatus 1, are conceivable. In addition, a storage installed in an external server system capable of communicating with the informing processor 4 properly can also be utilized.

The output unit 6 is one that outputs the data for providing information supplied from the informing processor 4. As the output unit 6, a display (display unit) and a speaker (sound output unit) are mentioned.

Incidentally, the vehicle information acquiring unit 2, the state deciding unit 3 and the informing processor 4 are implemented by a concrete means which causes hardware and software to cooperate with each other, in which a CPU constituting the vehicle state informing apparatus 1 executes programs describing the vehicle state informing processing of the embodiment 1 in accordance with the present invention.

Next, the operation will be described.

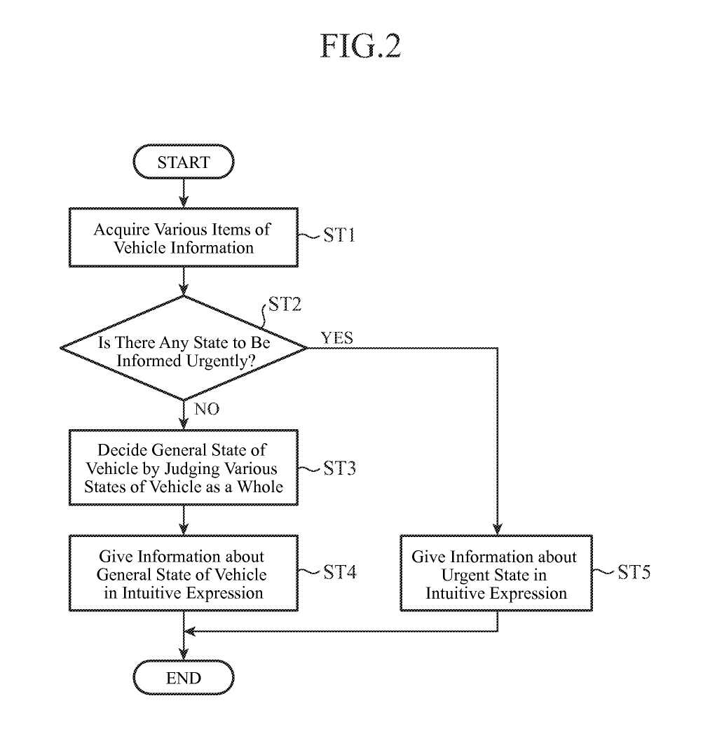

FIG. 2 is a flowchart showing a moving body state informing method of the embodiment 1.

First, the vehicle information acquiring unit 2 acquires the vehicle information from the vehicle in which the vehicle state informing apparatus 1 of the embodiment 1 is mounted (step ST1). The vehicle information acquired by the vehicle information acquiring unit 2 is supplied to the state deciding unit 3.

The state deciding unit 3, receiving the vehicle information from the vehicle information acquiring unit 2, decides whether the various states of the vehicle the vehicle information indicates includes a state to be informed urgently or not (step ST2).

For example, it decides the state with the point of the various states not less than the prescribed threshold as the state to be informed urgently as described above.

When there is not a state to be informed urgently (NO at step ST2), the state deciding unit 3 estimates the contents of the various states of the vehicle the vehicle information indicates as a whole, thereby deciding the general state of the vehicle (step ST3). For example, it decides the contents of the general state of the vehicle from the various states by calculating the points corresponding to the various states as described above. The decision result of the general state of the vehicle is supplied from the state deciding unit 3 to the informing processor 4.

Next, the informing processor 4 supplies the output unit 6 with the general state of the vehicle the state deciding unit 3 decides, thereby giving information (step ST4).

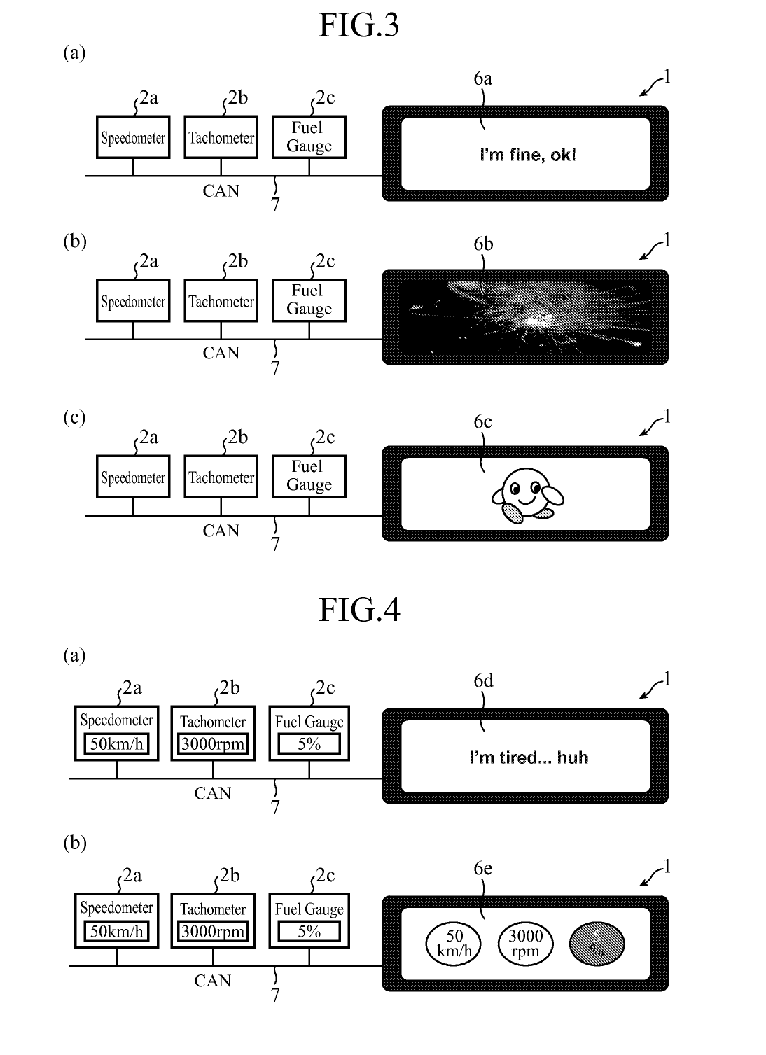

FIG. 3 is a diagram showing information examples of the general state of the vehicle, which shows the general states of the vehicle when the various states are the vehicle speed, engine speed and remaining amount of fuel. In FIG. 3, the speedometer 2a, tachometer 2b and fuel gauge 2c are connected to a CAN (Controller Area Network) 7, and the vehicle information acquiring unit 2 acquires the vehicle information captured by the speedometer 2a, tachometer 2b and fuel gauge 2c via the CAN 7. In addition, the examples of FIG. 3 show the cases where the speed of the vehicle, the engine speed and the remaining amount of fuel have the normal values. At this time, the state deciding unit 3 decides the general state of the vehicle as a “running well and fuel is enough” state, and the informing processor 4 informs of the state decided by the state deciding unit 3 in the intuitive expression as a “fine” state of the vehicle.

FIG. 3(a) shows a case which informs a user of the general state of the vehicle in the intuitive expression using a text (vehicle is “fine”). Here, a sentence “I'm fine, OK!” is displayed on the screen 6a of the display constituting the output unit 6. By visually confirming the screen 6a, even a user without knowledge about the various states of the vehicle can recognize intuitively that the vehicle is in a “fine” state without any problem about the running of the vehicle. Accordingly, the driver can continue driving while perceiving the vehicle state without being misled by the values of the complicated meters during the driving.

In addition, the intuitive expression enables the driver who is necessary to concentrate on the driving to grasp the vehicle state at once. Incidentally, the foregoing sentence can be output in voice.

FIG. 3(b) shows a case which informs a user of the general state of the vehicle (vehicle is “fine”) in the intuitive expression using a visual effect based on a motion of a color. Here, the screen 6b displays a visual effect of a white flash moving on the screen with a bluish black background at random in conjunction with the running of the vehicle.

By visually confirming the screen 6b, even a user without knowledge about the various states of the vehicle can recognize intuitively that the vehicle is in a “fine” state without any problem about the running of the vehicle.

Incidentally, in the case of the screen 6b, since it is not necessary to read a sentence, even a driver concentrating on the driving is able to grasp the vehicle state at once. In addition, even during the normal driving in which it is not necessary to confirm the meter information in detail, it is effective because the driver can grasp the vehicle state easily.

In addition, the intuitive expression using the visual effect is not limited to that shown in FIG. 3(b). For example, it is conceivable to express, during the normal driving, in a design using a blue color as to which the effect of the mental composure is proved, and to alter, if an abnormality occurs in the vehicle state, to a design using red which is a warning color, and to make the movement of the color more active.

FIG. 3(c) shows a case which informs a user of the general state of the vehicle (vehicle is “fine”) in the intuitive expression using a comic character and its motion. Here, an image in which a humanoid comic character is running is displayed on the screen 6c. By visually confirming the screen 6c, even a user without knowledge about the various states of the vehicle can recognize intuitively that the vehicle is in a “fine” state without any problem about the running of the vehicle. Incidentally, the intuitive expression using the comic character is not limited to that shown in FIG. 3(c). For example, it is also possible to use, during the normal driving, an image with a comic character laughing or relaxing, and to use, if an abnormality occurs in the vehicle states, an image with the comic character noticing the abnormality or alarming in confusion. In this case, it can amuse the user more than the visual effect shown in FIG. 3(b), thereby being able to expect to relax the driving stress.

Let us return to the description of FIG. 2.

When a state to be informed urgently occurs (YES at step ST2), the state deciding unit 3 supplies the information indicating the state of the decision result to the informing processor 4. Thus, the informing processor 4 gives information about the state to be informed urgently using an intuitive expression (step ST5).

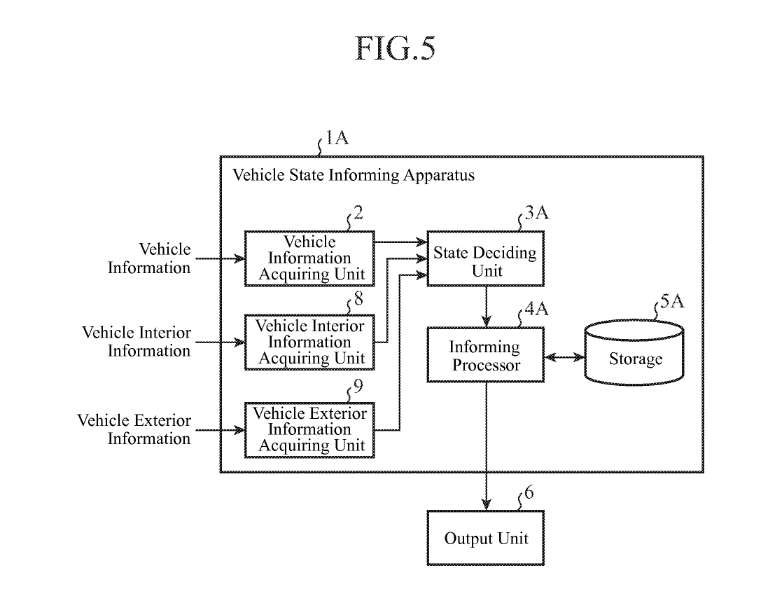

FIG. 4 is a diagram showing an information example when the information to be given urgently occurs. It shows the case where the remaining amount of fuel becomes the state to be informed urgently (remaining quantity 5%) among the vehicle speed, engine speed and remaining amount of fuel. When the state occurs which is decided to be informed urgently by the state deciding unit 3, the informing processor 4 switches from giving the information about the general state of the vehicle as shown in FIG. 3 to giving the information about the various states containing the state to be informed urgently.

FIG. 4(a) shows the information about the general state of the vehicle given in a text with an intuitive expression when the remaining amount of fuel has an urgent value. Here, the sentence “I'm tired . . . huh” is displayed on a screen 6d of the display constituting the output unit 6. By visually confirming the screen 6d, even a user without knowledge about the various states of the vehicle can recognize at once that the remaining quantity of the fuel reduces and the vehicle is in a state of being tired. This makes it possible to prompt the user to drive with less fuel consumption.

In addition, if the state where the remaining amount of fuel is an urgent value continues without oil supply even when a prescribed time period has elapsed after the start of the information shown in FIG. 4(a), the informing processor 4 switches from giving the information about the general state of the vehicle to giving the information about the various states containing the state to be informed urgently as shown in FIG. 4(b). Here, the individual values of the speedometer, tachometer and fuel gauge are displayed on the screen 6e, and the value of the fuel gauge is shown distinctively from the other values.

In this way, if the user does not understand the urgent state, the apparatus shows the various states concretely each, thereby prompting the user to understand the state to be dealt with urgently. In the case of FIG. 4(b), the user can easily recognize that the remaining amount of fuel has a problem by displaying the fuel gauge value on a different color background such as red which is the warning color.

Incidentally, the informing processor 4 can switch between giving the information about the general state of the vehicle and giving the information about the various states of the vehicle in response to a user operation through an operation input unit not shown. In this case, if the user wants to know the rough state of the vehicle as a whole, the user can select the information about the general state of the vehicle through the user operation, and if the user wants to know the details of the various states, the user can select the various states of the vehicle. This makes it possible to improve the user convenience.

In addition, a configuration is also possible in which the state deciding unit 3 decides the load state of the crew member (driver) of the vehicle in accordance with the traveling time or the distance covered by the vehicle acquired as the vehicle information, and the informing processor 4 can switch between giving the information about the general state of the vehicle and giving the information about the various states of the vehicle in conformity with the load state of the crew member the state deciding unit 3 decides. In this case, the state deciding unit 3 has a threshold set in advance for the traveling time or the distance covered, and decides that the driving load of the driver is in a high state when the traveling time or the distance covered is not less than the threshold. For example, when the driving load of the driver is in a high state, the informing processor 4 gives information about the general state of the vehicle, thereby preventing the driver from distracting from the driving with such performance as reading meters. In contrast, when the driving load of the driver is low, and the user has the leeway to do such performance as reading meters in addition to the driving, the apparatus gives information about the various states of the vehicle.

Furthermore, a configuration is also possible in which the state deciding unit 3 decides the position of the vehicle from the positional information about the vehicle acquired as the vehicle information, and the informing processor 4 switches between giving the information about the general state of the vehicle and giving the information about the various states of the vehicle in conformity with the position of the vehicle the state deciding unit 3 decides.

For example, when the vehicle is running along an expressway, the apparatus gives information about the general state of the vehicle because it is not necessary to read the meters in detail, but is enough to maintain a constant running state.

On the other hand, when the vehicle is running along a road like a climbing lane as to which fuel consumption is to be considered, the apparatus gives the information about the various states of the vehicle to enable the user to recognize the concrete value of the tachometer or the like.

As described above, according to the present embodiment 1, it comprises the vehicle information acquiring unit 2 that acquires the vehicle information indicating the various states of the vehicle; the state deciding unit 3 that decides the general state of the vehicle by estimating as a whole the contents of the various states of the vehicle indicated by the vehicle information the vehicle information acquiring unit 2 acquires; and the informing processor 4 that outputs the general state of the vehicle the state deciding unit 3 decides to the output unit 6 to give information to a user. With the configuration, the user can recognize the general state of the vehicle easily even if the user does not have the skills to recognize the various states of the vehicle appropriately.

In addition, according to the present embodiment 1, since the informing processor 4 switches between giving the information about the general state of the vehicle and giving the information about the various states of the vehicle in conformity with the prescribed condition, it can improve the user convenience by switching the information between the rough state and the concrete various states of the vehicle in response to the user operation. As the prescribed condition, for example, there are among the various states of the vehicle, the state having the information to be given urgently, the case designated by the user operation, the case where the driving load of the driver state becomes high, or the case where the vehicle is placed at a prescribed position.

Furthermore, according to the present embodiment 1, the informing processor 4 gives information about the general state or the various states of the vehicle by the intuitive expression using at least one of the character, color, shape, pattern, comic character and voice. By thus doing, the user can recognize the general state or various states of the vehicle at once. In addition, the intuitive expression with a unique movement of the comic character is expected to relax the driving stress.

### Embodiment 2

In the embodiment 2, the apparatus decides the general state of the vehicle by estimating as a whole the various states inside the vehicle and various states around the vehicle besides the various states the vehicle information indicates. By thus doing, it can grasp the vehicle state further in conformity with the actual conditions.

FIG. 5 is a block diagram showing a configuration of a moving body state informing apparatus of the embodiment 2 in accordance with the present invention. As in the embodiment 1, it is an apparatus which is mounted in or brought into a moving body such as a vehicle to give information about the state of the moving body to a crew member. The following description will be made using an example in which the moving body is a vehicle.

The vehicle state informing apparatus 1A shown in FIG. 5 comprises the vehicle information acquiring unit 2, a state deciding unit 3A, an informing processor 4A, a storage 5A, a vehicle interior information acquiring unit 8 and a vehicle exterior information acquiring unit 9.

Incidentally, in FIG. 5, the same components as those of FIG. 1 are designated by the same reference numerals, and their description will be omitted.

The state deciding unit 3A decides the general state of the vehicle by estimating as a whole the contents of the various states of the vehicle indicated by the vehicle information the vehicle information acquiring unit 2 acquires, the contents of the various states inside the vehicle indicated by the vehicle interior information the vehicle interior information acquiring unit 8 acquires, and the contents of the various states around the vehicle indicated by the vehicle exterior information the vehicle exterior information acquiring unit 9 acquires. As for the deciding method of the general state of the vehicle, it decides the contents of the general state of the vehicle from the various states by calculating the points corresponding to the various states the vehicle interior information indicates and the various states the vehicle exterior information indicates in the same manner as the case of the vehicle information shown in the embodiment 1.

In this way, the state deciding unit 3A obtains, as the information indicating the general state of the vehicle, the estimated values (point values) of the individual states and the total estimated value (the total value of the point values) by estimating the contents of the states by combining a plurality of vehicle states, a plurality of vehicle interior states, and a plurality of vehicle exterior states, which are selected in advance.

The informing processor 4A gives information by supplying the output unit 6 with the general state of the vehicle the state deciding unit 3A decides. More specifically, the informing processor 4A selects, from the expression data (stored in the storage 5) set in advance in conformity with the estimated values of the individual states, the expressions corresponding to the estimated values of the individual states (point values) acquired from the state deciding unit 3A as the information indicating the general state of the vehicle, and creates the data for providing information that expresses the general state of the vehicle by combining the individual expressions selected. Incidentally, as in the embodiment 1, the apparatus can also give information about the general state of the vehicle the state deciding unit 3A decides in an intuitive expression using at least one of the character, color, shape, pattern, comic character and voice. Besides, in addition to the various states of the vehicle information, it can give information about the various states of the vehicle interior information and about the various states of the vehicle exterior information in an intuitive expression.

As for a method of giving information about the general state of the vehicle and a method of giving information about various states thereof, they are the same as those of the embodiment 1.

The storage 5A is one that stores the data for providing information used in the informing processing by the informing processor 4A. Incidentally, besides the various states of the vehicle information, the storage 5A stores the data for providing information about the various states of the vehicle interior information and about the various states of the vehicle exterior information. For example, the data for providing information about a state of a crew member in the vehicle and about a state of an external obstacle can be conceived.

The vehicle interior information acquiring unit 8 has a function of a moving body interior information acquiring unit that acquires vehicle interior information indicating the various states inside the vehicle. For example, it is connected with a vehicle internal camera for taking the inside of the vehicle and acquires the vehicle interior information. The term “vehicle interior information” refers to the information mainly indicating whether the vehicle crew member is in a normal state or not, and has various states such as an expression of the driver taken with the vehicle internal camera, an amount of motion of eyes, a frequency of motion of eyes, an amount of motion of an in-vehicle person and the like. In addition, it can be connected to a bio-sensor for detecting bio-information (such as a heart rate and body temperature) of the driver to acquire the bio-information as the vehicle interior information.

The various states inside the vehicle include at least one of the expression of the driver inside the vehicle, the amount of motion of eyes, the frequency of motion of eyes, the bio-information (a heart rate, body temperature and the like) of a crew member (inclusive of the driver) and the amount of motion of a crew member.

The vehicle exterior information acquiring unit 9 has a function of a moving body exterior information acquiring unit that acquires the vehicle exterior information indicating the various states around the vehicle. For example, it is connected to a vehicle external camera for taking the surroundings of the vehicle, to a radar for detecting objects around the vehicle, or to an external sensor like a ultrasonic sensor, and acquires the vehicle exterior information.

The term “vehicle exterior information” refers to the information indicating the vehicle surrounding conditions, and has various states such as a surrounding vehicle density, a road sign, a warning sign, and the presence or absence of an obstacle or the like, which are taken with the vehicle external camera.

Incidentally, the various states around the vehicle include at least one of the surrounding vehicle density, the road sign, warning sign, and the presence or absence of an obstacle around the vehicle.

Incidentally, as for the vehicle information acquiring unit 2, the vehicle interior information acquiring unit 8, the vehicle exterior information acquiring unit 9, the state deciding unit 3A and the informing processor 4A, they are implemented by a concrete means which causes hardware and software to cooperate with each other, in which the CPU constituting the vehicle state informing apparatus 1A executes programs describing the vehicle state informing processing of the embodiment 2 in accordance with the present invention.

Next, the operation will be described.

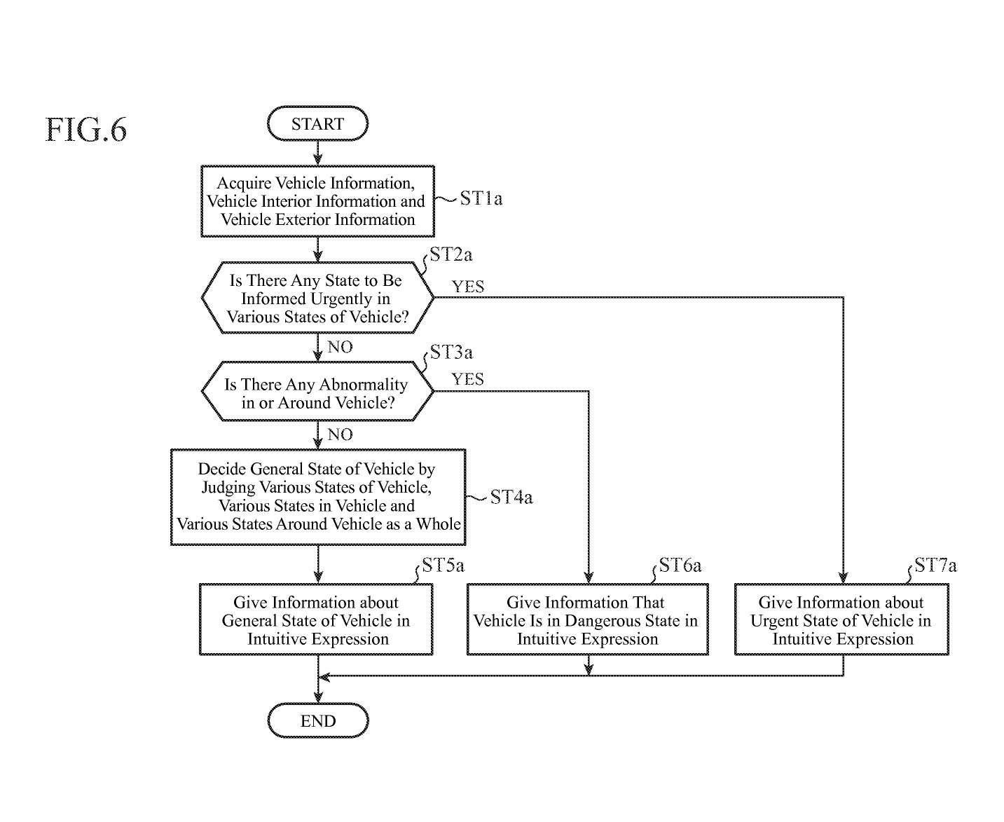

FIG. 6 is a flowchart showing a moving body state informing method of the embodiment 2.

First, the vehicle information acquiring unit 2 acquires the vehicle information from the vehicle in which the vehicle state informing apparatus 1A of the embodiment 2 is mounted, the vehicle interior information acquiring unit 8 acquires the vehicle interior information from the inside of the vehicle in which vehicle state informing apparatus 1A is mounted, and the vehicle exterior information acquiring unit 9 acquires the vehicle exterior information from the outside of the vehicle in which the vehicle state informing apparatus 1A is mounted (step ST1a). The vehicle information, the vehicle interior information and the vehicle exterior information acquired by the vehicle information acquiring unit 2, the vehicle interior information acquiring unit 8 and the vehicle exterior information acquiring unit 9 are supplied to the state deciding unit 3A.

The state deciding unit 3A, receiving the vehicle information, vehicle interior information and vehicle exterior information, decides whether a state to be informed urgently occurs in the various states the vehicle information indicates or not (step ST2a).

For example, as described before in the embodiment 1, it decides that a state with a point of the various states not less than the prescribed threshold as a state to be informed urgently.

Unless the state to be informed urgently takes place (NO at step ST2a), the state deciding unit 3A decides from the vehicle interior information and the vehicle exterior information whether an abnormality occurs in or around the vehicle (step ST3a). For example, it analyzes the awakening state of the driver by comparing the expression of the driver, the amount of motion of eyes, and the frequency of motion of eyes indicated by the vehicle interior information with reference data at the normal driving. Here, if it judges that the driver is in a panic state (hyperarousal state) or dozing state (hypoarousal state), it decides that an abnormality occurs in the vehicle. In addition, the state deciding unit 3A decides that an abnormality occurs in the surroundings of the vehicle when it judges that the surrounding vehicle density indicated by the vehicle exterior information is not less than the prescribed threshold, and hence the vehicle is caught in a traffic jam and the distance from the vehicle ahead is too close, or when it judges that the vehicle is in a surrounding condition to reduce the speed of the vehicle according to a road sign or a warning sign.

Deciding that an abnormality does not occur in or around the vehicle (NO at step ST3a), the state deciding unit 3A decides the general state of the vehicle by estimating as a whole the contents of the various states of the vehicle the vehicle information indicates, the contents of the various states inside the vehicle the vehicle interior information indicates and the contents of the various states around the vehicle the vehicle exterior information indicates (step ST4a). For example, as described before in the embodiment 1, the state deciding unit 3A decides the contents of the general state of the vehicle from the various states by calculating the points corresponding to the various states. The decision result of the general state of the vehicle is supplied from the state deciding unit 3A to the informing processor 4A.

As the general state of the vehicle in this case, for example, there is a state in which the “running is good and the driver is fine, and the distance from the vehicle ahead is enough”.

The informing processor 4A supplies the general state of the vehicle the state deciding unit 3A decides to the output unit 6, and gives information about it (step ST5a). When the general state of the vehicle is a state in which the “running is good and the driver is fine, and the distance from the vehicle ahead is enough”, the information is given in an intuitive expression indicating that there is no problem outside the vehicle, and that both the vehicle and driver are in a “fine” state. For example, it is conceivable to display an image in which a comic character representing the vehicle and a comic character representing the driver are running. In addition, if an obstacle is detected outside the vehicle, it is also possible to add a comic character corresponding to the type of the obstacle to the image.

If it decides that an abnormality occurs in or around the vehicle (YES at step ST3a), the state deciding unit 3A supplies the informing processor 4A with the fact. Thus, if the state deciding unit 3A judges that an abnormality occurs in the various states inside the vehicle or in the various states around the vehicle, the informing processor 4A gives information that the vehicle is in a dangerous state in an intuitive expression (step ST6a).

For example, if the driver is in a panic state (hyperarousal state) or in a dozing state (hypoarousal state) (abnormality inside the vehicle), or in a condition to reduce the speed because the road of the vehicle is a deceleration road or because the distance from the vehicle ahead is less than the allowable value owing to a traffic jam (abnormality around the vehicle), it is necessary to cause the driver to recognize to decelerate at once. Accordingly, the apparatus gives information that the vehicle is in a dangerous state now in an intuitive expression by reducing the threshold of the warning speed.

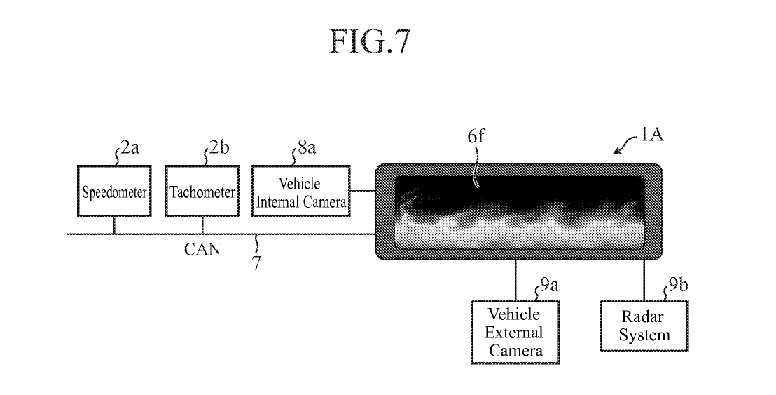

FIG. 7 is a diagram showing an information example when an abnormality occurs in or around the vehicle, which shows the information indicating that the abnormality occurs in or around the vehicle and the vehicle is in a dangerous state in an intuitive expression. In FIG. 7, the speedometer 2a, tachometer 2b and fuel gauge 2c are connected to a CAN 7 as in FIG. 3, and the vehicle information acquiring unit 2 acquires the vehicle information captured with the speedometer 2a, tachometer 2b and fuel gauge 2c via the CAN 7. In addition, the vehicle interior information acquiring unit 8 is connected to the vehicle internal camera 8a, and acquires the vehicle interior information such as photographed image information of the driver. The vehicle exterior information acquiring unit 9 is connected to the vehicle external camera 9a and radar system 9b, and acquires the vehicle exterior information such as photographed image information around the vehicle and a distance to an obstacle (other vehicle).

FIG. 7 shows a case where the driver is in a panic state (hyperarousal state) or in a dozing state (hypoarousal state) (abnormality inside the vehicle), or is in a condition to reduce the speed because the road of the vehicle is a deceleration road or the distance to the vehicle ahead is less than the allowable value owing to a traffic jam (abnormality around the vehicle), and hence it is necessary to prompt the driver to decelerate. At this time, for example, displaying the screen 6f of flames enables the driver to recognize intuitively that the vehicle is in a dangerous condition, thereby being able to prompt the driver to decelerate. The screen 6f is continued until the driver decelerates to a safe speed, or until the state in or around the vehicle returns to a normal state. In addition, unless the driver decelerates immediately, the informing processor 4A can alter the screen to a warning color or can increase the tempo of the music being played while the speaker constituting the output unit 6 is outputting a voice.

Let us return to the description of FIG. 6.

If a state to be informed urgently occurs (YES at step ST2a), the state deciding unit 3A supplies the information indicating the state of the decision result to the informing processor 4A. The informing processor 4A gives information about the state to be informed urgently in an intuitive expression (step ST7a). The details of the processing are the same as those at step ST5 of FIG. 2 in the embodiment 1.

In addition, although the embodiment 1 shows the case which decides the driving load state of the driver from the traveling time of the vehicle or the distance covered by the vehicle, in the embodiment 2, the state deciding unit 3A can decide the load state of the crew member from the bio-information about the crew member of the vehicle (driver) acquired as the vehicle interior information, and the informing processor 4A can switch between giving the information about the general state of the vehicle and giving the information about the various states of the vehicle the in conformity with the load state of the driver the state deciding unit 3A decides. For example, if the state deciding unit 3A decides from the bio-information such as the driver's heart rate or body temperature that the driving load is in a high state, the informing processor 4A gives information indicating that the vehicle is in a dangerous state in an intuitive expression.

As described above, according to the present embodiment 2, it comprises the vehicle interior information acquiring unit 8 that acquires the vehicle interior information indicating the various states inside the vehicle; and the vehicle exterior information acquiring unit 9 that acquires the vehicle exterior information indicating the various states around the vehicle, wherein the state deciding unit 3A decides the general state of the vehicle by estimating as a whole the contents of the various states of the vehicle indicated by the vehicle information the vehicle information acquiring unit acquires, the contents of the various states inside the vehicle indicated by the vehicle interior information the vehicle interior information acquiring unit 8 acquires, and the contents of the various states around the vehicle indicated by the vehicle exterior information the vehicle exterior information acquiring unit 9 acquires. With such a configuration, even a user without skills of appropriately recognizing the various states of the vehicle, the various states inside the vehicle, and the various states around the vehicle can recognize the general state of the vehicle easily.

In addition, according to the present embodiment 2, the state deciding unit 3A decides the load state of the crew member according to the bio-information about the crew member of the vehicle acquired as the vehicle interior information, and the informing processor 4A switches between giving information about the general state of the vehicle and giving information about the various states of the vehicle in conformity with the load state of the crew member of the vehicle the state deciding unit 3A decides. By thus doing, the user can switch between the case of wishing to know the rough state of the vehicle or the case of wishing to know the concrete various states, thereby being able to improve the user convenience.

Furthermore, according to the present embodiment 2, the state deciding unit 3A decides whether the various states inside the vehicle or various states around the vehicle have an abnormality or not, and when it decides that the various states inside the vehicle or various states around the vehicle have an abnormality, the informing processor 4A gives information that the vehicle is in a dangerous state in an intuitive expression. By thus doing, if an abnormality occurs in the various states in or around the vehicle, the apparatus can cause the user to recognize that the vehicle is in a dangerous state intuitively.

### Embodiment 3

The embodiment 3 shows a case that identifies an informing target user, and gives information about the general state of the vehicle or the various states of the vehicle in a different mode in conformity with the informing target user.

By thus doing, it can prevent the information from concentrating upon the driver, and can reduce the load of the driver, his or her misreading, failure to recognize an important message of the vehicle and the like, for example.

In addition, when giving information about the general state of the vehicle in an intuitive expression, the informing target user does not need the skills to read the meters. Accordingly, even a family member without a license can recognize the vehicle state.

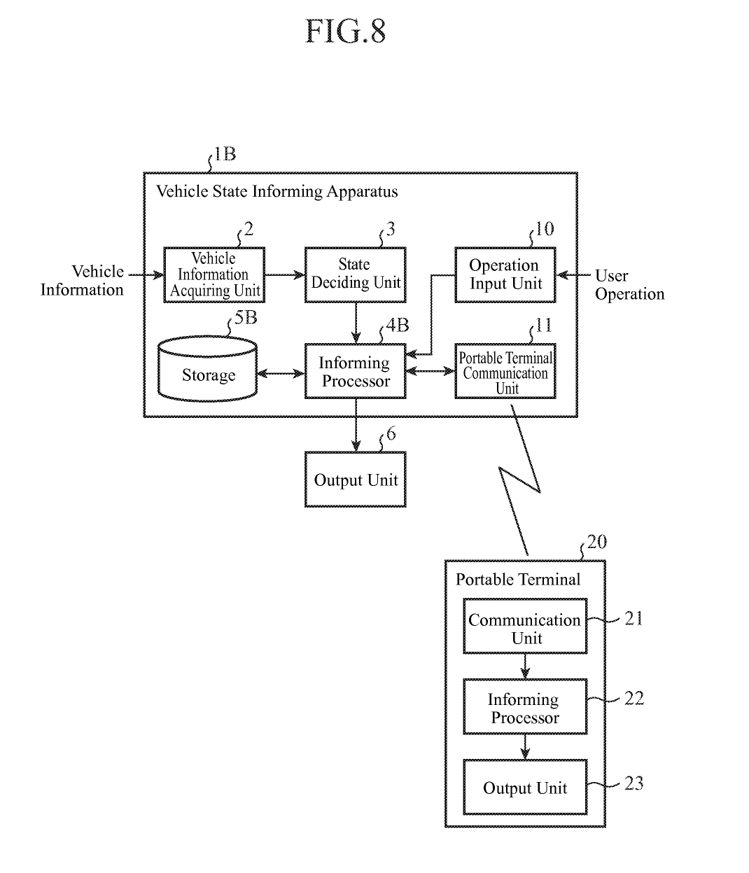

FIG. 8 is a block diagram showing a configuration of a moving body state informing apparatus of the embodiment 3 in accordance with the present invention. As the embodiment 1, it is an apparatus that is mounted in or brought into a moving body such as a vehicle, and gives information about the state of the moving body to a crew member. The following description will be made by way of example where the moving body is a vehicle.

In addition, in FIG. 8, the vehicle state informing apparatus 1B not only outputs the information to the output unit 6, but also gives information to a portable terminal 20.

It is assumed here that the portable terminal 20 is carried by a “child” in the passenger seat sharing the vehicle, and the “father” in the driving seat of the vehicle is driving, and that the output unit 6 comprises a display and an in-vehicle speaker built in the instrument panel.

The vehicle state informing apparatus 1B comprises the vehicle information acquiring unit 2, the state deciding unit 3, an informing processor 4B, a storage 5B, an operation input unit 10 and a portable terminal communication unit 11.

In addition, the portable terminal 20, which is a mobile data terminal such as a smartphone or tablet PC, comprises a communication unit 21, an informing processor 22 and an output unit 23. Incidentally, in FIG. 8, the same components as those of FIG. 1 are designated by the same reference symbols, and their description will be omitted.

The informing processor 4B is a communication processor that supplies or transmits the general state of the vehicle the state deciding unit 3 decides to the output unit 6 or to the portable terminal 20 to give information, and that switches the mode of informing in conformity with an informing target user.

Incidentally, as the embodiment 1, the present embodiment 3 can give information about the general state of the vehicle the state deciding unit 3 decides in an intuitive expression using at least one of the character, color, shape, pattern, comic character and voice.

In addition, if the present embodiment 3 comprises the vehicle interior information acquiring unit 8 and the vehicle exterior information acquiring unit 9 as the embodiment 2, it can give information about the various states of the vehicle interior information and the various states of the vehicle exterior information besides the various states of the vehicle information in an intuitive expression.

The storage 5B is a storage that stores data for providing information used in the informing processing by the informing processor 4B. Incidentally, in addition to the data for providing information with a format capable of being presented by the output unit 6, the storage 5B stores the data for providing information capable of being presented by the portable terminal 20. For example, it includes image data for providing information, which fits the size of the screen of the output unit 23 of the portable terminal 20.

The operation input unit 10, which has a function of receiving a user operation, is connected to a keybutton and a touch panel of hardware, for example, and accepts a user operation. Using the operation input unit 10 enables the informing processor 4B to set an informing target user. For example, “father” is set as a user to whom the output unit 6 gives information, and “child” is set as a user to whom the portable terminal 20 gives information.

The portable terminal communication unit 11 has a function of carrying out communication with the communication unit 21 of the portable terminal 20.

For example, it is implemented through a communication unit with a communication scheme such as a wireless LAN (Local Area Network), Bluetooth (a registered trade mark, the mention of which will be omitted below), Ethernet (a registered trade mark, the mention of which will be omitted below), MOST (Media Oriented Systems Transport) or the like.

The communication unit 21 of the portable terminal 20 is a communication unit that carries out communication with the portable terminal communication unit 11 of the vehicle state informing apparatus 1B, and carries out communication using a wireless LAN, Bluetooth, Ethernet, MOST or the like as well.

The informing processor 22 is an informing processor that supplies the output unit 23 with the vehicle state received from the vehicle state informing apparatus 1B via the communication unit 21 to give information.

The output unit 23 is an output unit that outputs the data for providing information, which is received from the informing processor 22. As the output unit 23, a display (display unit) and a speaker (sound output unit) built into the portable terminal 20 are mentioned.

Incidentally, as for the vehicle information acquiring unit 2, the state deciding unit 3, the informing processor 4B, the operation input unit 10 and the portable terminal communication unit 11, they are implemented as a concrete means which causes hardware and software to cooperate with each other, in which the CPU constituting the vehicle state informing apparatus 1B executes programs describing the vehicle state informing processing of the embodiment 3 in accordance with the present invention.

Next, the operation will be described.

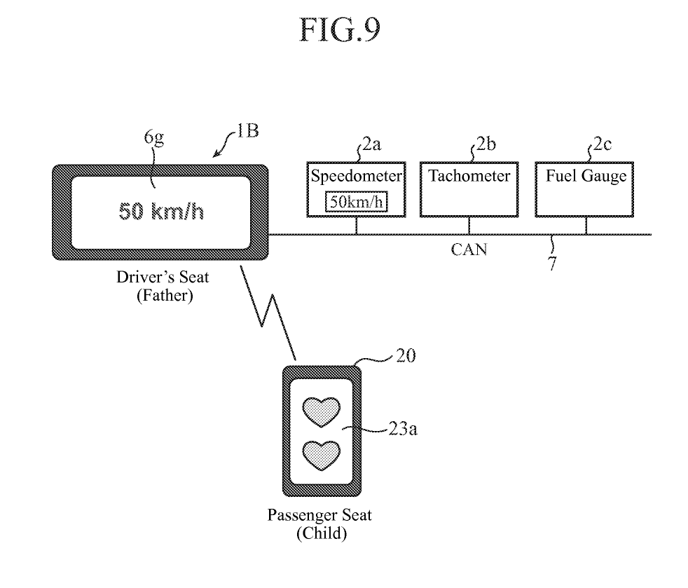

FIG. 9 is a diagram showing an information example about the vehicle state of the embodiment 3, which shows the general state of the vehicle when the various states are the vehicle speed, the engine speed and the remaining amount of fuel. In FIG. 9, the speedometer 2a, tachometer 2b and fuel gauge 2c are connected to the CAN 7, and the vehicle information acquiring unit 2 acquires the vehicle information captured with the speedometer 2a, tachometer 2b and fuel gauge 2c via the CAN 7. Incidentally, FIG. 9 shows a case where the speed, engine speed and remaining amount of fuel of the vehicle are a normal value. For example, the speed of the vehicle is 50 km/h.

In addition, it is assumed that using the operation input unit 10, a user designates the informing target of the output unit 6 as “father” and the informing target of the portable terminal 20 as “child” in the informing processor 4B.

Incidentally, as a method by which the informing processor 4B identifies the informing target user, besides the method of assigning as described above through the operation input unit 10, there is a method of fixedly setting the informing target of the output unit 6 and the informing target of the portable terminal 20 in advance.

In addition, a configuration is also possible in which the state deciding unit 3 identifies the informing target of the output unit 6 and the informing target of the portable terminal 20 by analyzing an image of a crew member in the vehicle, which the vehicle interior information acquiring unit 8 acquires, and in which the informing processor 4B acquires the analysis result.

Receiving the general state of the vehicle and the various states of the vehicle the state deciding unit 3A decides, the informing processor 4B gives information about the various states of the vehicle to the “father” and about the general state of the vehicle to the “child” in an intuitive expression in accordance with the contents of the informing target users designated.

More specifically, for the user (“father”) with the skills to read the meters, who is also the driver of the vehicle, it gives information about the various states of the vehicle necessary for the driving. On the other hand, for the user (“child”) without the skills, it is enough to give information about the general state of the vehicle in an intuitive expression.

In the example of FIG. 9, the state deciding unit 3 judges the general state of the vehicle as “running is good and fuel is enough”. At this time, the informing processor 4B represents the state decided by the state deciding unit 3 in a heart-shaped intuitive expression as a state in which the vehicle is “fine”, and gives the information to the portable terminal 20 via the portable terminal communication unit 11. Thus, the screen 23a of the portable terminal 20 displays the heart shapes indicating that the vehicle is in a “fine” state intuitively.

In addition, the informing processor 4B supplies the output unit 6 with the speed of the vehicle which is one of the various states of the vehicle, and thus the screen 6g of the output unit 6 displays the speed of the vehicle (50 km/h) necessary for the driving.

Incidentally, it is also possible to enable a user to select a state of which he or she wishes to be informed through the operation input unit 10.

For example, if a passenger (a crew member who does not drive) in the passenger seat wishes to find the speed of the vehicle, the portable terminal 20 is selected to give information about the speed of the vehicle by the informing processor 4B using the operation input unit 10.

In addition, when the apparatus comprises the vehicle interior information acquiring unit 8 and the vehicle exterior information acquiring unit 9 as the embodiment 2, a configuration is also possible which alters the informing modes dynamically for each user in conformity with the various states inside the vehicle or various states around the vehicle.

For example, if the vehicle internal camera detects dozing (hypoarousal state) of the driver, the passenger in the passenger seat is informed that the vehicle is in a dangerous state in an intuitive expression through the portable terminal 20 the passenger carries. This enables the passenger to urge the driver to pay attention.

In addition, if the vehicle external camera or radar system detects that an obstacle approaches within a dangerous distance from a vehicle direction which is driver's blind spot, the output unit 6 displays an intuitive expression to give information that the vehicle is in a dangerous state. This enables the driver to find the danger of the obstacle.

Incidentally, although FIG. 8 shows the example that gives information via the output unit 6 and the portable terminal 20 using the data for providing information stored in the storage 5B of the vehicle state informing apparatus 1B, the embodiment 3 is not limited to it.

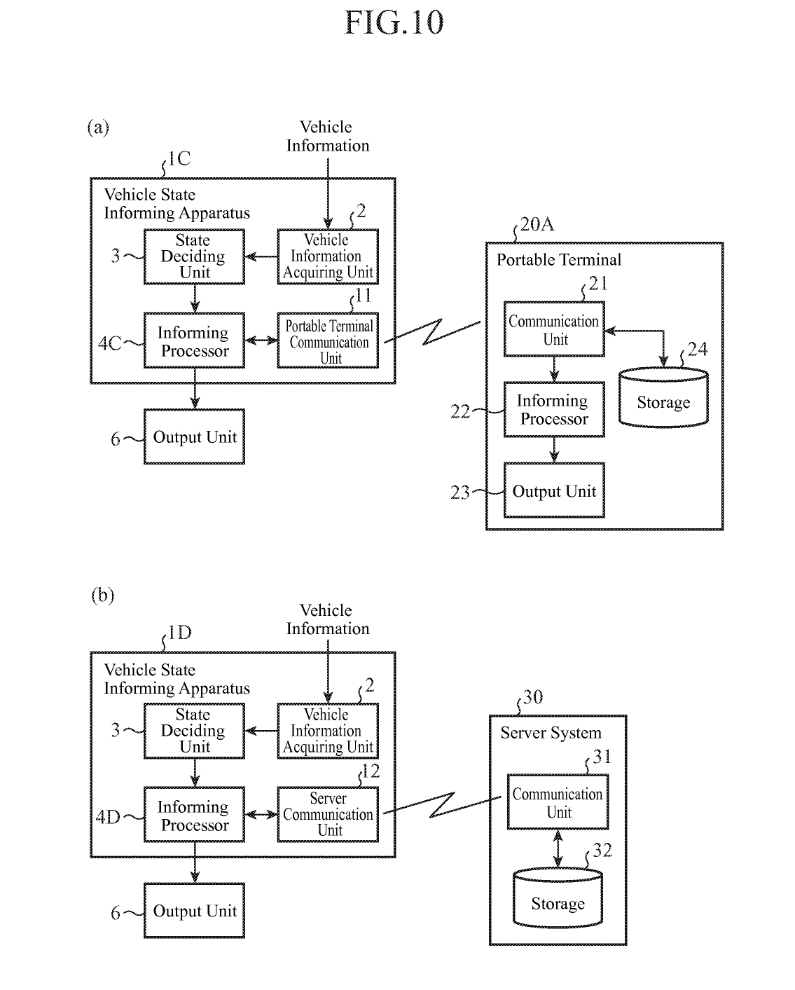

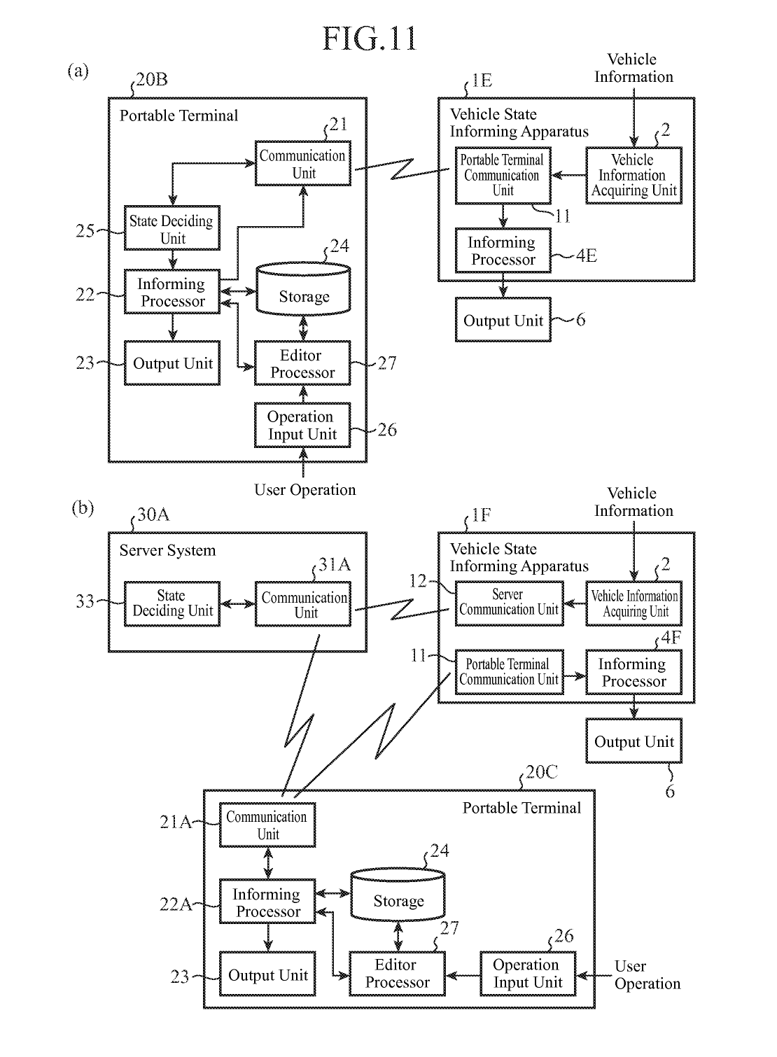

For example, as shown FIG. 10(a), a configuration is also possible which gives information via the output unit 6 and portable terminal 20A using the data for providing information stored in a storage 24 provided in the portable terminal 20A.

More specifically, the storage 24 stores in advance the data for providing information composed at least one of the character, color, shape, pattern, comic character and voice capable of being processed by the output unit 6 and portable terminal 20A. The vehicle state informing apparatus 1C receives the data for providing information from the portable terminal 20A via the portable terminal communication unit 11, and the informing processor 4C gives information about the general state of the vehicle and the various states of the vehicle. The portable terminal 20A receives the vehicle state from the vehicle state informing apparatus 1C via the communication unit 21, and the informing processor 22 supplies it to the output unit 23 to give information.

In addition, as shown in FIG. 10(b), a configuration is also possible which uses the data for providing information, which is stored in a storage 32 a server system 30 comprises, to give information via the output unit 6 or portable terminal 20.

In FIG. 10(b), the server system 30 comprises a communication unit 31 and the storage 32, and the communication unit 31 carries out communication with a vehicle state informing apparatus 1D. In addition, the storage 32 stores the data for providing information composed at least one of the character, color, shape, pattern, comic character and voice capable of being processed by the output unit 6 and portable terminal 20.

The vehicle state informing apparatus 1D comprises a server communication unit 12 that carries out communication with the server system 30, and receives the data for providing information from the server system 30 via the server communication unit 12. Thus, an informing processor 4D gives information about the general state of the vehicle and the various states of the vehicle using the data for providing information received from the server system 30.

Incidentally, the server communication unit 12 is a communication unit that makes a communication connection with a communication network like the Internet, and is able to carry out communication properly with the server system 30 connected to the communication network.

As described above, according to the present embodiment 3, the informing processor 4B switches between giving information about the general state of the vehicle and giving information about the various states of the vehicle in conformity with an informing target user. By thus doing, it can switch between the case where the user wants to know the rough state of the vehicle and the case the user wants to know the concrete various states in conformity with the informing target user.

In addition, it can avoid the concentration of the information upon a particular user (such as the driver), and can reduce the load of the user (driver), his or her misreading, failure to recognize an important message. Furthermore, when giving information about the general state of the vehicle in the intuitive expression, the user does not need skills to read the meters. Accordingly, even a family member without the license can recognize the vehicle state.

In addition, according to the present embodiment 3, it comprises the portable terminal communication unit 11 that carries out communication with the portable terminal 20, and the informing processor 4B gives information to the portable terminal 20 via the portable terminal communication unit 11.

By thus doing, it can give information about the vehicle state to the user of the portable terminal 20, thereby being able to improve the convenience of the vehicle state informing apparatus in accordance with the present invention.

Furthermore, according to the present embodiment 3, it comprises the portable terminal communication unit 11 that carries out communication with the portable terminal 20A, and the informing processor 4C acquires at least one of the character, color, shape, pattern, comic character and voice from the portable terminal 20A via the portable terminal communication unit 11, and gives information about the vehicle state in an intuitive expression. With the configuration, even if the vehicle state informing apparatus 1C does not have a storage for storing the data for providing information, it can give information about the vehicle state.

Furthermore, according to the present embodiment 3, it comprises the server communication unit 12 that carries out communication with the server system 30, and the informing processor 4D acquires at least one of the character, color, shape, pattern, comic character and voice from the server system 30 via the server communication unit 12, and gives information about the vehicle state in an intuitive expression. With the configuration, even if the vehicle state informing apparatus 1D does not have a storage for storing the data for providing information, it can give information about the vehicle state.

### Embodiment 4

In the embodiment 4, the vehicle state informing apparatus gives information about contents edited by the portable terminal. By thus doing, it can conduct communication between a user who is an informing target of the output unit and a user who is an informing target of the portable terminal via the informing contents.

FIG. 11 is a block diagram showing a configuration of a moving body state informing apparatus of the embodiment 4 in accordance with the present invention. In the configuration shown in FIG. 11(a), the portable terminal 20B comprises a state deciding unit 25, an operation input unit 26 and an editor processor 27 in addition to the configuration of FIG. 8.

The state deciding unit 25 decides the general state of the vehicle using the various states of the vehicle it receives from a vehicle state informing apparatus 1E via the communication unit 21. In the same manner as in the embodiment 1, a deciding method of the general state of the vehicle decides the contents of the general state of the vehicle by calculating the points corresponding to the various states of the vehicle.

Incidentally, when the vehicle state informing apparatus comprises the vehicle interior information acquiring unit 8 and the vehicle exterior information acquiring unit 9, it can decide the general state of the vehicle using the various states inside the vehicle or various states around the vehicle.

The operation input unit 26 has a function of receiving a user operation, and sets, for example, editing contents input by a user operation in the editor processor 27.

The editor processor 27 is an editor processor that edits the informing contents in accordance with the editing contents input by the user operation. For example, when giving information about the vehicle state in a comic character, the editor processor 27 adds a comic character with a new design, or makes a minor alteration of the design of a comic character. In addition, when operating the comic character in accordance with a prescribed scenario, it can alter the scenario.

Furthermore, the editor processor 27 can receive the various states of the vehicle successively via the informing processor, specify an inclination of state changes from the various states of the vehicle during a prescribed period, and edit the informing contents in conformity with the inclination.

In addition, the vehicle state informing apparatus 1E comprises the vehicle information acquiring unit 2, the portable terminal communication unit 11, and an informing processor 4E. The vehicle state informing apparatus 1E does not comprise the state deciding unit, and transmits the vehicle information the vehicle information acquiring unit 2 acquires to the portable terminal 20B via the portable terminal communication unit 11.

The portable terminal 20B receives the vehicle information from the vehicle state informing apparatus 1E via the communication unit 21. In the portable terminal 20B, the state deciding unit 25 decides the vehicle state using the vehicle information it receives from the vehicle state informing apparatus 1E, and the informing processor 22 creates the information about the vehicle state using the data for providing information stored in the storage 24.

In the vehicle state informing apparatus 1E, the portable terminal communication unit 11 receives the information about the vehicle state created by the portable terminal 20B, and the informing processor 4E outputs the information about the vehicle state it receives to the output unit 6 to give information.

In the configuration shown in FIG. 11(b), the server system 30A comprises a communication unit 31A and a state deciding unit 33. The communication unit 31A is a communication unit that carries out communication between the vehicle state informing apparatus 1F and the portable terminal 20C. The state deciding unit 33 decides the general state of the vehicle using the various states of the vehicle it receives from the vehicle state informing apparatus 1F via the communication unit 31A. As for the deciding method of the general state of the vehicle, it is the same as that described above. Incidentally, the state deciding unit 33 transmits the decision result of the general state of the vehicle and the various states of the vehicle to the portable terminal 20C via the communication unit 31A.

Although the portable terminal 20C has basically the same configuration as the portable terminal 20B of FIG. 11(a), a communication unit 21A and an informing processor 22A execute different processing.

First, the communication unit 21A is a communication unit that carries out communication with the server system 30A in addition to the vehicle state informing apparatus 1F. The informing processor 22A receives the vehicle state from the server system 30A via the communication unit 21A, and creates the information about the vehicle state using the data for providing information stored in the storage 24. The informing processor 22A supplies the information it creates to the output unit 23 to give information to its user, and transmits it to the vehicle state informing apparatus 1F via the communication unit 21A to cause the output unit 6 to give information to its user.

With the configurations as shown in FIG. 11(a) and FIG. 11(b), the apparatus can carry out communication between the informing target user of the output unit 6 and the informing target user of the portable terminals 20B and 20C via the informing contents. Incidentally, as for the present embodiment 4, a configuration is also possible which adds the operation input unit 26 and editor processor 27 to the portable terminal 20 of FIG. 8 shown in the embodiment 3.

Next, the operation will be described.

Here, a case will be described in which the configuration as shown in FIG. 11(a) gives information about the vehicle state.

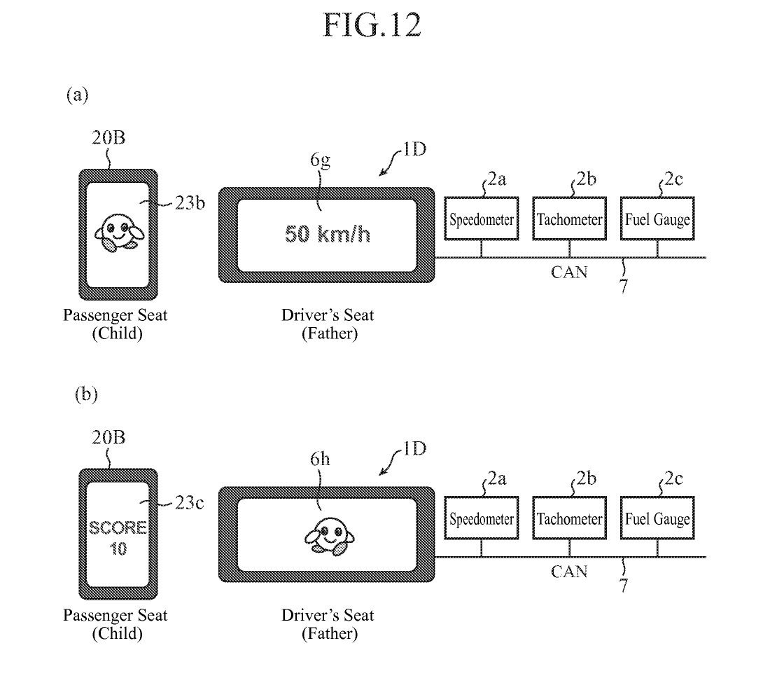

FIG. 12 is a diagram showing an information example about the vehicle state in the embodiment 4, which shows the general state of the vehicle when the various states are the vehicle speed, the engine speed and the remaining amount of fuel. In FIG. 12, the speedometer 2a, tachometer 2b and fuel gauge 2c are connected to the CAN 7, and the vehicle information acquiring unit 2 acquires the vehicle information captured with the speedometer 2a, tachometer 2b and fuel gauge 2c through the CAN 7. Incidentally, FIG. 12 shows a case where the speed of the vehicle, engine speed and remaining amount of fuel take the normal values such as when the speed of the vehicle is 50 km/h. In addition, it is assumed that the informing target of the output unit 6 is “father”, and the informing target of the portable terminal 20B is “child”.

In FIG. 12(a), the state deciding unit 25 of the portable terminal 20B decides that the general state of the vehicle is a “running is good and fuel is enough” state. At this time, the informing processor 22 of the portable terminal 20B expresses the state decided by the state deciding unit 25 intuitively by a comic character as a state where the vehicle is “fine”, and outputs it to the screen 23b of the output unit 23, thereby giving the information.

Furthermore, the informing processor 22 transmits the speed of the vehicle which is one of the various states of the vehicle to the vehicle state informing apparatus 1E via the communication unit 21. Thus, the output unit 6 of the vehicle state informing apparatus 1E displays on its screen 6g the speed of the vehicle (50 km/h) necessary for the driving.

After that, when the vehicle is stopped, since the information about the speed of the vehicle given through the output unit 6 becomes 0 km/h which is obvious, it can give information different from the information during the running of the vehicle.

In this case, the output unit 6 can give information about the general state of the vehicle in an intuitive expression. For example, in the example shown in FIG. 12(b), a comic character gives information about the state where the vehicle is “fine” in an intuitive expression, which is output on the screen 6h of the output unit 6 to give information.

Incidentally, a configuration is also possible in which the editor processor 27 transmits the informing contents it edits to the vehicle state informing apparatus 1E, and the vehicle state informing apparatus 1E gives the informing contents after editing to the user. For example, it is conceivable to add a new comic character to the comic character that has been output from the output unit 23, or to edit into only a new comic character through a minor alteration.

In addition, the editor processor 27 can receive the various states of the vehicle successively via the informing processor 22, can specify the inclination of the state alteration from the various states of the vehicle during a prescribed interval, and can edit the informing contents corresponding to it.

For example, in the case of FIG. 12(b), the editor processor 27 creates the driving score from the time rate of change of the speed acquired during the running of the vehicle, and gives information by outputting it to the screen 23c of the output unit 23. Incidentally, the term “driving score” refers to a score given to the time rate of change of the vehicle state in conformity with a prescribed rule. For example, the editor processor 27 can give the score depending on whether the time rate of change agrees with the time rate of change of the speed considered as ecological driving or not. Thus, referring to the driving score enables even a passenger (“child”) who does not know driving well to recognize whether the driving was the ecological driving or not.

As described above, according to the present embodiment 4, the informing processor 4E or 4F receives the information edited by the portable terminal 20B or 20C via the portable terminal communication unit 11, and gives information through the output unit 6.

By thus doing, the communication via the informing contents is carried out between the user who is the informing target of the output unit 6 and the user who is the informing target of the portable terminal 20B or 20C. This is expected to relieve the stress of the driver, for example.

In addition, according to the present embodiment 4, the state deciding unit 25 decides the general state of the vehicle using the various states of the vehicle indicated by the vehicle information acquired from the vehicle state informing apparatus 1E, and the informing processor 22 outputs the general state of the vehicle decided to the output unit 6 to give information to the user.

With such a configuration, it can offer the same advantages as described above.

Furthermore, according to the present embodiment 4, the server system 30A comprises the state deciding unit 33 that decides the general state of the vehicle using the various states of the vehicle indicated by the vehicle information acquired from the vehicle state informing apparatus 1F via the communication unit 31, and the communication unit 31 transmits the general state of the vehicle the state deciding unit 33 decides to the vehicle state informing apparatus 1F to cause it to give the information. With such a configuration, it can offer the same advantages as described above.

In the embodiments 1-4, although the examples are shown in which the moving body is a vehicle, a moving body state informing apparatus in accordance with the present invention is an apparatus that gives information about the state of the moving body including a person, a vehicle, a railway vehicle, a ship or an aircraft, and is a device particularly suitable for being brought into or mounted in the vehicle.

Incidentally, it is to be understood that a free combination of the individual embodiments, variations of any components of the individual embodiments or removal of any components of the individual embodiments is possible within the scope of the present invention.

### INDUSTRIAL APPLICABILITY

A vehicle state informing apparatus in accordance with the present invention enables a user to recognize the general state of a moving body easily, even if the user does not have skills of recognizing the various states of the moving body. Accordingly, it is suitable for an application to a display device that displays images of various meters indicating the states of a vehicle, for example.

### DESCRIPTION OF REFERENCE SYMBOLS

1, 1A-1F vehicle state informing apparatus; 2 vehicle information acquiring unit; 2a speedometer; 2b tachometer; 2c fuel gauge; 3, 3A, 25, 33 state deciding unit; 4, 4A-4F, 22, 22A informing processor; 5, 5A, 5B, 24, 32 storage; 6, 23 output unit; 6a-6h screen; 7 CAN; 8 vehicle interior information acquiring unit; 8a vehicle internal camera; 9 vehicle exterior information acquiring unit; 9a vehicle external camera; 9b radar system; 10, 26 operation input unit; 11 portable terminal communication unit; 12 server communication unit; 20, 20A-20C portable terminal; 21, 21A, 31, 31A communication unit; 27 editor processor; 30, 30A server system.

1-17. (canceled)

18. A moving body state informing apparatus which is mounted in a moving body to give information about a state of the moving body via an output unit, the moving body state informing apparatus comprising:
a moving body information acquirer that acquires moving body information indicating various states of the moving body;
a state decider that decides a general state of the moving body by estimating as a whole contents of the various states of the moving body indicated by the moving body information the moving body information acquirer acquires;
and
an informing processor that outputs the general state of the moving body the state decider decides to the output unit to give information, wherein the informing processor switches between giving information about the general state of the moving body and giving information about the various states of the moving body in conformity with a prescribed condition.

19. The moving body state informing apparatus according to claim 18, wherein the informing processor gives information about the general state of the moving body or about the various states of the moving body in an intuitive expression using at least one of a character, color, shape, pattern, comic character and voice to give.

20. The moving body state informing apparatus according to claim 18, wherein
the state decider decides a state to be informed urgently from the various states of the moving body; and
the informing processor switches between giving information about the general state of the moving body and giving information about the various states including the state to be informed urgently in response to a decision result of the state decider.

21. The moving body state informing apparatus according to claim 18, wherein the informing processor switches between giving the information about the general state of the moving body and giving the information about the various states of the moving body in conformity with an informing target user.

22. The moving body state informing apparatus according to claim 18, wherein the informing processor switches between giving the information about the general state of the moving body and giving the information about the various states of the moving body in response to a user operation.

23. The moving body state informing apparatus according to claim 18, wherein
the state decider decides a load state of a crew member of the moving body from a travel time or a travel distance of the moving body; and
the informing processor switches between giving the information about the general state of the moving body and giving the information about the various states of the moving body in conformity with the load state of the crew member the state decider decides.

24. The moving body state informing apparatus according to claim 18, wherein
the state decider decides a location of the moving body from positional information about the moving body acquired as the moving body information; and
the informing processor switches between giving the information about the general state of the moving body and giving the information about the various states of the moving body in conformity with the location of the moving body the state decider decides.

25. The moving body state informing apparatus according to claim 18, further comprising:
a moving body interior information acquirer that acquires moving body interior information indicating various states in the moving body; and
a moving body exterior information acquirer that acquires moving body exterior information indicating various states around the moving body, wherein
the state decider decides a general state of the moving body by estimating as a whole the contents of the various states of the moving body indicated by the moving body information the moving body information acquirer acquires, contents of the various states in the moving body indicated by the moving body interior information the moving body interior information acquirer acquires, and contents of the various states around the moving body indicated by the moving body exterior information the moving body exterior information acquirer acquires.

26. The moving body state informing apparatus according to claim 25, wherein
the state decider decides the load state of a crew member from bio-information about the crew member of the moving body acquired as the moving body interior information; and
the informing processor switches between giving the information about the general state of the moving body and giving the information about the various states of the moving body in conformity with the load state of the crew member of the moving body the state decider decides.

27. The moving body state informing apparatus according to claim 25, wherein
the state decider decides whether the various states in the moving body or the various states around the moving body have an abnormality or not; and
the informing processor gives information through an intuitive expression that the moving body is in a dangerous state if the state decider decides that the various states in the moving body or the various states around the moving body have the abnormality.

28. The moving body state informing apparatus according to claim 18, further comprising:
a portable terminal communicator that carries out communication with a portable terminal, wherein
the informing processor gives information to the portable terminal via the portable terminal communicator.

29. The moving body state informing apparatus according to claim 28, wherein the informing processor acquires at least one of a character, color, shape, pattern, comic character and voice from the portable terminal via the portable terminal communicator, and gives information about the state of the moving body using an intuitive expression.

30. The moving body state informing apparatus according to claim 28, wherein the informing processor receives information edited in the portable terminal through the portable terminal communicator, and gives information through the output unit.

31. The moving body state informing apparatus according to claim 18, further comprising:
a server communicator that carries out communication with a server system, wherein
the informing processor acquires at least one of a character, color, shape, pattern, comic character and voice from the server system via the server communicator, and gives information about the state of the moving body using an intuitive expression.

32. A server system including a communicator that carries out communication with a moving body state informing apparatus, and that causes the moving body state informing apparatus to inform of a state of a moving body via the communicator, the server system comprising:
a state decider that decides a general state of the moving body by estimating as a whole contents of various states of the moving body indicated by moving body information acquired from the moving body state informing apparatus via the communicator, wherein
the communicator transmits the general state of the moving body the state decider decides to the moving body state informing apparatus to cause the moving body state informing apparatus to give information, and switches between giving information about the general state of the moving body and giving information about the various states of the moving body in conformity with a prescribed condition.

33. A moving body state informing method that causes a moving body state informing apparatus to give information about a state of a moving body via an output unit of the moving body state informing apparatus, the moving body state informing method comprising:
deciding by a state decider a general state of the moving body by estimating as a whole contents of various states of the moving body indicated by moving body information acquired from the moving body state informing apparatus; and
outputting by an informing processor the general state of the moving body decided to the output unit to give information, and switching between giving information about the general state of the moving body and giving information about the various states of the moving body in conformity with a prescribed condition.
